(19) United States
(12) Patent Application Publication
(10) Pub. No.: US 2010/0131836 A1
(43) Pub. Date: May 27, 2010

(54) USER-AUTHORED NOTES ON SHARED DOCUMENTS

(75) Inventors: Marina Dukhon, Kirkland, WA (US); Greg Lewis, Woodinville, WA (US); Portia Plante, Seattle, WA (US); Jesse Clay Satterfield, Seattle, WA (US); Christopher C. Yu, Setagaya (JP)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/276,874

(22) Filed: Nov. 24, 2008

(51) Int. Cl. G06F 17/00

(52) U.S. Cl. 715/230

(57) ABSTRACT

User-authored notes on shared documents may be provided. A shared document may be stored and at least one note may be associated with the document. When a user displays the document, the associated not may be retrieved and a user interface element may be provided to allow the user to view the note.

### BACKGROUND

User-authored notes on shared documents represent a process for exposing comments about a document to users of the document. In some situations, there is no intuitive way for a document's author to notify readers about information pertaining to the whole document. For example, document authors may wish to notify other users of updated sections or provide background details. Thus, the conventional strategy is to send email or include messages within the document. This often causes problems because the conventional strategy does not necessarily provide the information in a readily accessible or intuitive manner. For example, emails may not remain associated with the document.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

User-authored notes on shared documents may be provided. A shared document may be saved and at least one note may be associated with the document. When a user displays the document, the associated note may be retrieved and a user interface element may be provided to allow the user to view the note.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of a user-authored note display;

FIG. 2 is a flow chart of a method for providing user-authored notes on shared documents;

FIG. 3A is a block diagram of a user-authored note displayed as an overlay;

FIG. 3B is a block diagram of an alternate arrangement of a user-authored note displayed as an overlay;

FIG. 4 is a block diagram of a user-authored note displayed adjacent to a shared document; and

FIG. 5 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

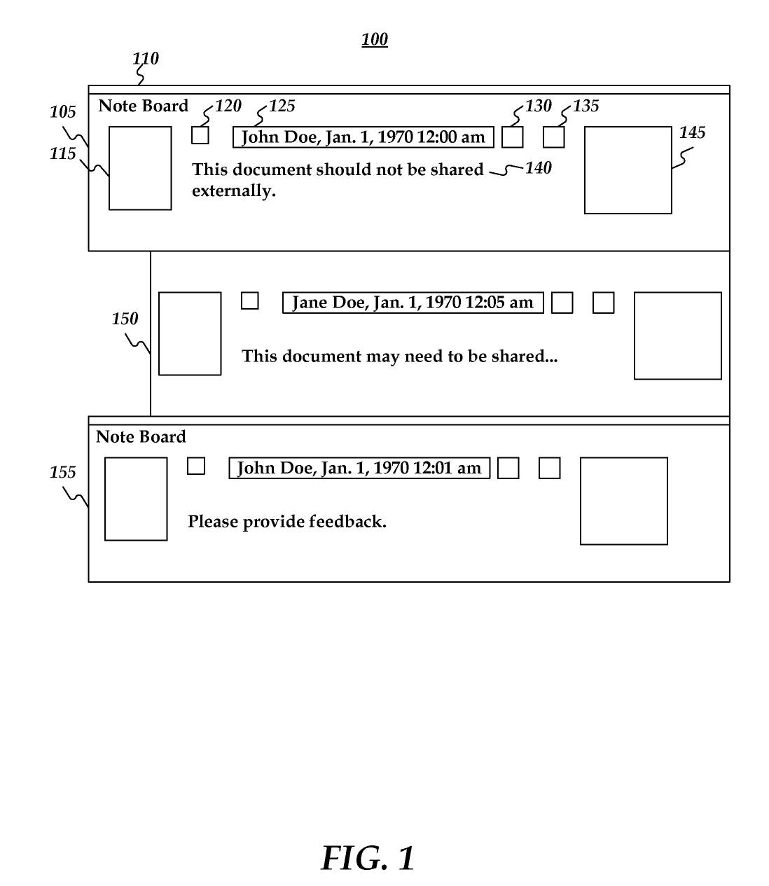

User-authored notes on shared documents may be provided. Consistent with embodiments of the present invention, FIG. 1 shows a block diagram of a user-authored notes display 100. Display 100 may comprise a note board including a first note 105, a reply note 150, and a second note 155. Consistent with embodiments of the invention, reply note 150 may be located below and/or indented relative to first note 105 when reply note 150 comprises a reply to first note 105. First note 105 may comprise a priority indicator 110, a user icon 115, a communicator icon 120, a note origin field 125, a priority icon 130, an edit button 135, a note text 140, and a command button 145. For example, priority indicator 110 may comprise a colored line across the top of first note 105 that may be colored red for a high priority note, yellow for a normal priority note, and green for a low priority note. Alternate color schemes are consistent with further embodiments of the invention, and embodiments of the invention may indicate priority by other means such as priority icon 130, a background pattern, a background color, and a border.

User icon 115 may comprise, for example, a picture of the note's author, an icon selected by the author, an icon assigned to the author, and/or an icon representing a category for the note. Communicator icon 120 may comprise an indicator of the note author's online status such as being colored green if the author is available and red or grey if the author is not available. A reader of the note may click on communicator icon 120 to send an IM to the note's author. Note origin field 125 may comprise information about the note comprising the author's name and the time the note was created. Priority icon 130 may comprise a graphical indicator for the note's priority. For example, an exclamation point may indicate a high priority note and a down arrow may indicate a low priority note. Consistent with embodiments of the invention, a user may click on priority icon 130 to change the priority of an existing note. Edit button 135, when selected, may be configured to present an interface to a viewer and/or author of a note allowing editing of the note's content and/or deleting the note. Note text 140 may comprise any text entered by the note's author. For example, the note's author may wish to inform readers of the document that the document should not be shared externally, that the document may be copyrighted, that feedback is requested, and/or may suggest background information to review to put the document in context, among other comments. Command button 145 may comprise a user interface control that, when selected, may allow a user to select, edit, delete, change priority, and/or re-order any displayed notes. Command button 145 may also allow a user to add a new note and/or reply to an existing note.

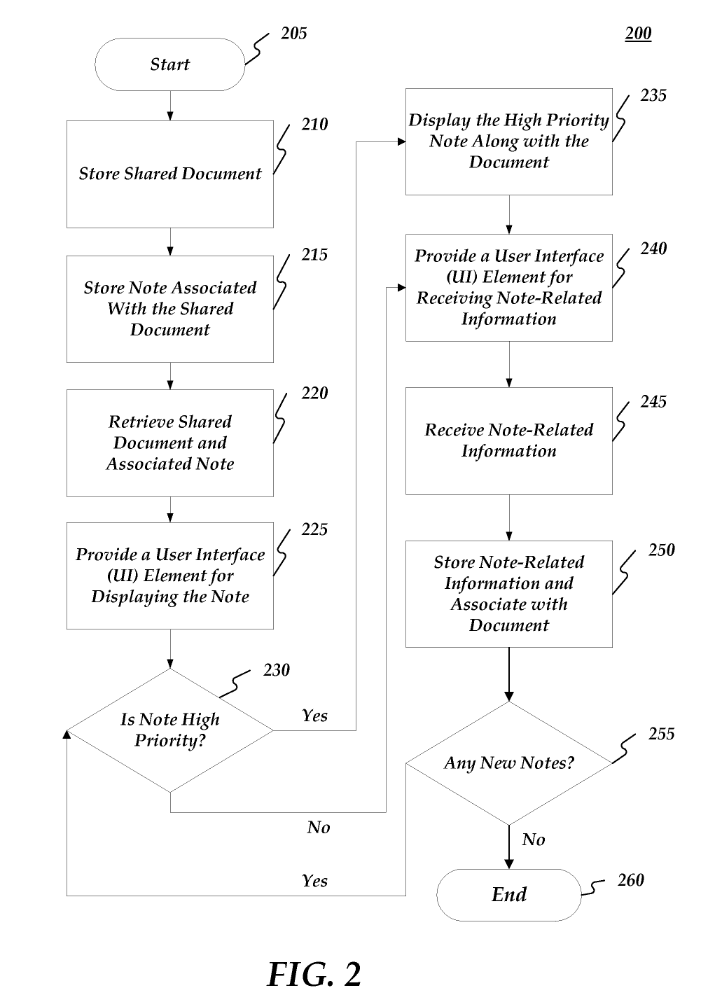

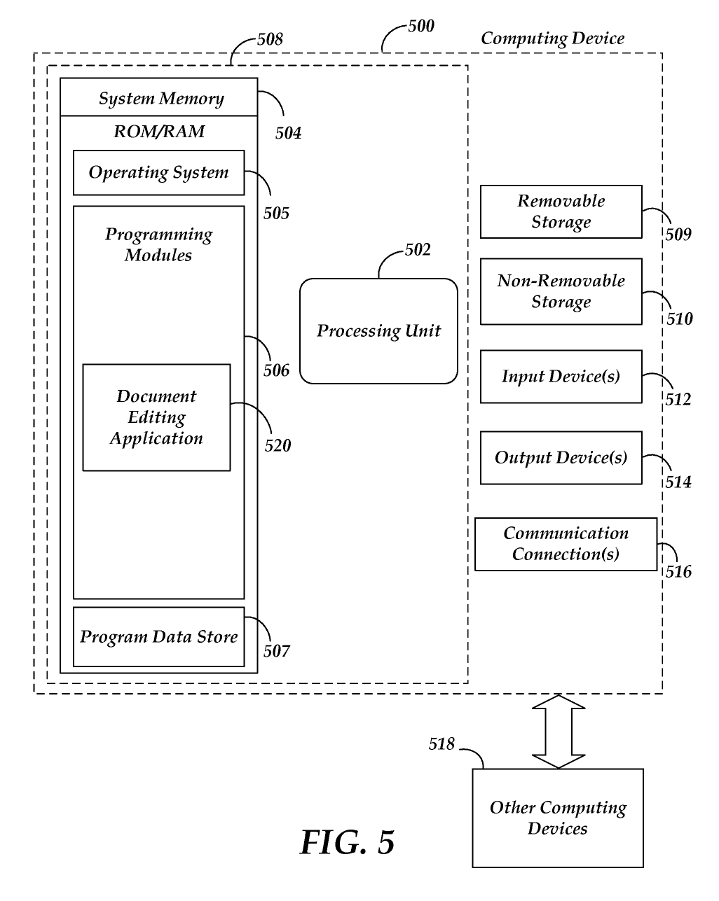

FIG. 2 is a flow chart setting forth the general stages involved in a method 200 consistent with an embodiment of the invention for providing user-authored notes on shared documents. Method 200 may be implemented using a computing device 500 as described in more detail below with respect to FIG. 5. Ways to implement the stages of method 200 will be described in greater detail below. Method 200 may begin at starting block 205 and proceed to stage 210 where computing device 500 may store a document. For example, computing device 500 may store an electronic word processing document intended to be shared with users other than the document author on a removeable storage 509 and/or a non-removeable storage 510 associated with computing device 500. Consistent with embodiments of the invention, the document may be stored on another computing device 518. Computing device 518 may be operatively connected to computing device 500 via a communication connection 516. For example, computing device 500 may send the document over the Internet to computing device 518 for storage on a SharePoint Server as produced by Microsoft® Corporation of Redmond, Wash.

From stage 210, where computing device 500 stored the document, method 200 may advance to stage 215 where computing device 500 may store a note associated with the document. For example, the document's author may add a note to the document to communicate information related to the document such as a caution not to share the document outside of a user's organization or group, background information, information regarding recent updates and/or revisions, and/or a request for comments and/or review. These are examples only, and the note text may be entered free-form by the note's author to include any text. The note may be associated with the document and stored to the same memory storage as the document or may be stored to an alternate memory storage than the document. Consistent with embodiments of the invention, computing device 500 may also store information about the note such as the note author's name, user icon, a timestamp the note was created, edited, and/or deleted, contact information for the note's author, and/or a priority level for the note.

Once computing device 500 stores the note associated with the shared document in stage 215, method 200 may continue to stage 220 where computing device 500 may retrieve the shared document and the associated note. For example, a user other than the document's author may open the shared document for display via a software application operating on computing device 500. Computing device 500 may retrieve the document and the associated note as part of the document opening process.

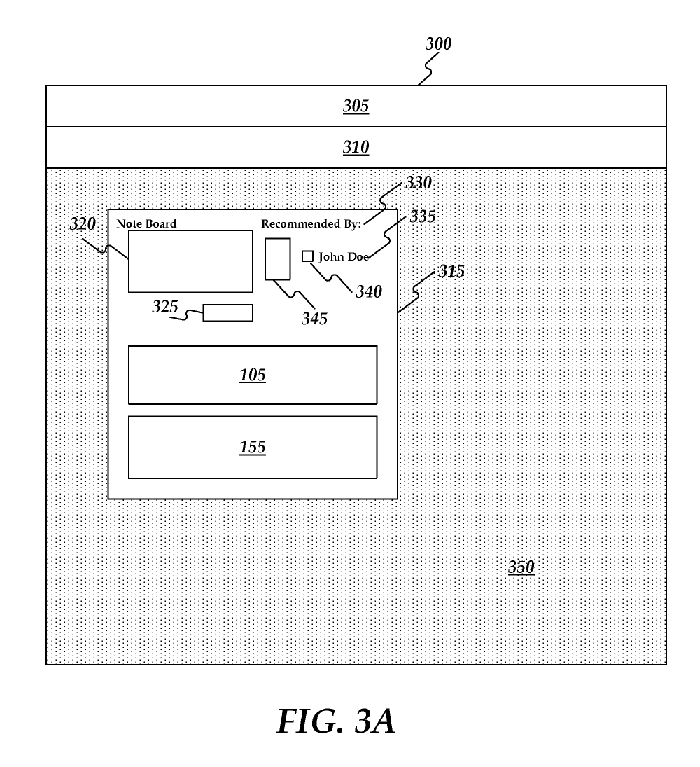

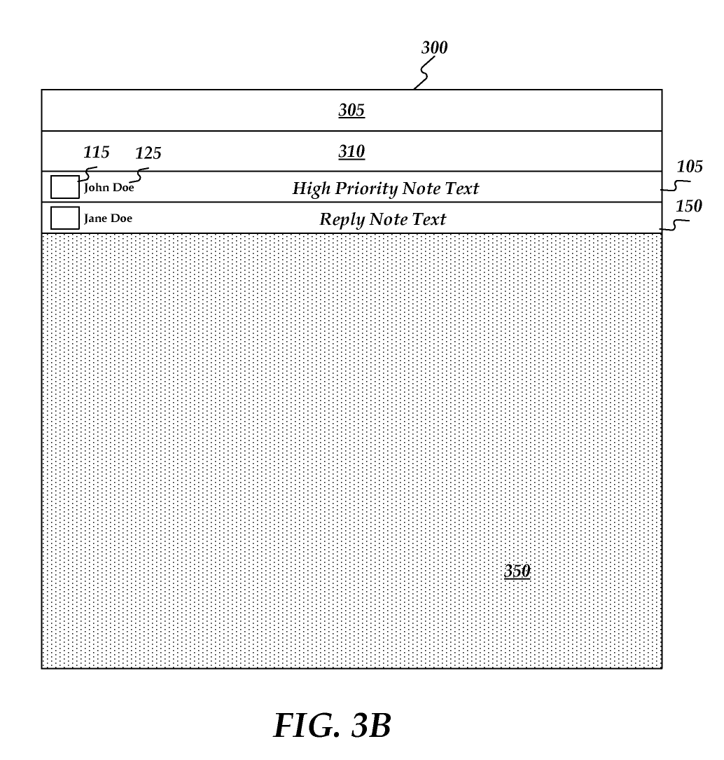

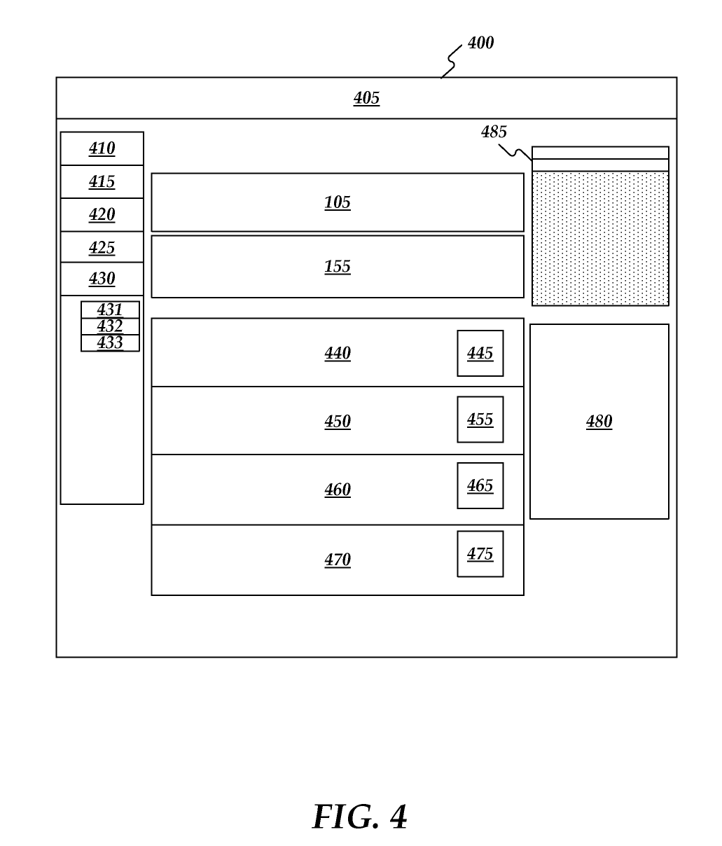

After computing device 500 retrieves the stored document and the associated note in stage 220, method 200 may proceed to stage 225 where computing device 500 may provide a user interface (UI) element for displaying the note. For example, computing device 500 may provide a menu option operable to display the note in the software application used to open the document. The user may select the UI element to cause the software application to display the associated note as described above with respect to FIG. 1, and further described below with respect to FIGS. 3A, 3B, and 4. Consistent with embodiments of the invention, multiple notes may be associated with the document and may be displayed as a group of all notes, a subset of available notes, and/or singly. For example, a UI element may be provided to display a subset of notes created by the same note author.

After computing device 500 provides the UI element in stage 225, method 200 may proceed to stage 230 where computing device 500 may determine whether the note associated with the document has been designated as high priority by the note's author and/or another user. For example, a note author may designate the note as high priority at the time the note is created. Consistent with embodiments of the invention, a user may review the note and change the note's priority to designate the note as high priority.

If computing device 500 determines at stage 230 that the note is designated as high priority, method 200 may advance to stage 235 where computing device 500 may display the high priority note along with the document even though the user may not have selected the UI element to display the note. Display configurations for displaying the note and the document simultaneously may be the same as though the user had selected the UI element as described above with respect to FIG. 1 and described further below with respect to FIGS. 3A, 3B, and 4. Consistent with embodiments of the invention, displaying the high priority note may comprise displaying an indicator to the user that the note is designated as high priority, as described above with respect to FIG. 1. Further consistent with embodiments of the invention, computing device 500 may determine whether any other notes associated with the document comprise reply notes to the high priority note. Reply notes to the high priority note may be displayed along with the high priority note.

Once computing device 500 displays the high priority note at stage 235 or if computing device 500 determines that the note associated with the document is not designated as high priority, method 200 may proceed to stage 245 where computing device 500 may provide a UI element for receiving note-related information. For example, computing device 500 may provide a note board interface within the software application operable to receive a new note to be associated with the document, to edit an existing note associated with the document, and/or to delete an existing note associated with the document. The note board interface may comprise an element operative to receive note message text, a priority selector, and a submission button. Consistent with embodiments of the invention, a new note may comprise a reply to an existing note and may be displayed adjacent to the existing note in order to indicate that the new note is a reply. Consistent with further embodiments of the invention, the UI element for receiving note-related information may comprise receiving a recommendation from one user to any and/or all other users of the document. Recommended notes may be treated as having a higher priority and/or may be displayed along with an indicator such as an icon, background color, color bar and/or border, colored text, and/or additional text to indicate their recommended status.

After computing device 500 receives the note-related information at stage 245, method 200 may proceed to stage 250 where computing device 500 may store the note-related information as described above with respect to stage 215 and associate the note-related information with the document.

After computing device 500 stores the note-related information at stage 250, method 200 may proceed to stage 255 where computing device 500 may determine whether any new notes and/or note-related information has been associated with the document. Computing device 500 may then retrieve the new note and/or note-related information and return to stage 230. For example, a user on another computer may have opened the same document and added a new, high priority note. Computing device 500 may then display the new, high priority note to the user of computing device 500. For another example, the user on the other computer may change an existing note's priority from normal to high. Computing device 500 may receive this note-related information and display the note to the user of computing device 500.

Consistent with embodiments of the invention, the determination of stage 255 may occur any time during the stages of method 200. For example, computing device 500 may check for new notes and/or note-related information at a set time interval regardless of any other note-related activity the user of computing device 500 undertakes. Consistent with further embodiments of the invention, computing device 500 may provide a UI element operative to check for new notes and/or note-related information upon selection by the user.

After completion of the stages above, method 200 may then end at stage 260. For example, method 200 may continue to check for new notes at stage 255 until the user closes the document. Method 200 may then store any changes to the document and/or notes associated with the document according to stages 210 and 215 before proceeding to stage 260.

FIG. 3A is a block diagram of a user-authored note displayed as an overlay to a software application 300. For example, software application 300 may be operative to open a document and may comprise an internet browser, an e-mail application, a document editing application, and/or other computer-based software applications. Software application 300 may comprise a title bar 305, a menu bar 310, an application display space 350. A note board 315 may be displayed as an overlay to software application 300 and may comprise a note entry field 320, a note entry command button 325, a note information field 330, first note 105 and second note 155. Note information field 330 may comprise any of the information described above with respect to first note 105, such as a user icon 345, a communicator icon 340, and a user name 335. Note board 315 may be displayed in response to a user's selection of a UI element operative to display note-related information, such as a menu option and/or a toolbar element. Software application 300 may provide a UI element operative to receive note-related information such as a new note, a reply note, an edit to an existing note, and/or a request to delete an existing note. Software application 300 may further provide a UI element operative to receive a change to a note's priority. Upon receiving edits to a note, including a change in the note's priority, the edits may be stored as described above with respect to method 200. Storing the edits may comprise storing the note's changed text, changed priority, information about the user making the changes, and/or a timestamp for the changes.

FIG. 3B is a block diagram of an alternate arrangement of a user-authored note displayed as an overlay. As with FIG. 3A, software application 300 may comprise title bar 305, menu bar 310, and application display space 350. First note 105 may be displayed across the top of application display space 350 without obscuring the document and may comprise any and/or all of the note elements discussed above with respect to FIG. 1, such as user icon 115 and note information field 125. Reply note 150 may be displayed below first note 105 and may comprise similar elements as first note 105. First note 105 and reply note 150 may be displayed as part of an in-space of software application 300 while non-displayed notes may be associated with an out-space of software application 300. The concepts of the in-space and the out-space of software application 300 are described in commonly owned and assigned U.S. patent application Ser. No. 11/823,999 filed Jun. 29, 2007, which is hereby incorporated by reference in its entirety.

FIG. 4 is a block diagram of a user-authored note displayed adjacent to a shared document. Consistent with embodiments of the invention, a software application 400 may be operative to open a document 485, and may comprise a title bar 405, a side menu comprising menu options 410, 415, 420, 425, and 430. Menu options 410, 415, 420, 425, and 430 may comprise sub-options, such as sub-options 431, 432, and 433 to menu option 430. For example, menu options 410, 415, 420, 425, and 430 may comprise a “Back” command to return to a previous document, an “Info” command to display properties, information, and/or notes associated with document 485, a “New” document command, an “Open” document command, a “Save” document command, a “Print” document command, a “Send” and/or “Share” document command, and an application specific menu. Menu option 430 may comprise the application specific menu, for a word processing application, for example, and may comprise sub-options relevant to the word processing application such as font, layout, and/or object embedding. Document 485 may comprise a reduced size view of software application 300 displayed adjacent to first note 105 and second note 155. Software application 400 may further comprise additional document command bars 440, 450, 460, and 470. Command bars 440, 450, 460, and 470 may each comprise a user interface element 445, 455, 465, and 475, respectively, that may comprise a button to execute an associated command.

Software application 400 may comprise a UI element operative to display the user-authored note when selected. Upon selection of the UI element, software application 400 may replace a display of the document similar to that of application display space 350 of FIG. 3B with the display of FIG. 4. Software application 400 may reduce the size of document 485 in order to display a smaller version of document 485 adjacent to the display of first note 105 and second note 155.

An embodiment consistent with the invention may comprise a system for providing document information. The system may comprise a memory storage and a processing unit coupled to the memory storage. The processing unit may be operative to store at least one note associated with a document, display the document, retrieve the at least one note, and provide a user interface element operative to display the at least one note. The at least one note may comprise information about the document intended to be shared with a plurality of users of the document.

Another embodiment consistent with the invention may comprise a system for providing information about a document accessible to a plurality of users. The system may comprise a memory storage and a processing unit coupled to the memory storage. The processing unit may be operative to store the document, store at least one note associated with the document, receive a request to open the document, open the document, provide the document for display, and provide the at least one note associated with the document. The processing unit may be further operative to determine whether the at least one note comprises a high priority note and display the high priority note as described above. Consistent with embodiments of the invention, the document may be stored on a shared document server. A client system comprising a memory storage and a processing unit may be provided in communication with the shared document server. The client system may be operative to receive a user command to open the document, send a request for the document to the shared document server, receive the document and the at least one note associated with the document, provide a menu element operative, when selected by the user, to display the at least one note, and to display the document.

Yet another embodiment consistent with the invention may comprise a system for providing document information. The system may comprise a memory storage and a processing unit coupled to the memory storage. The processing unit may be operative to store the document and an associated note on a shared document server, retrieve the document and the associated note from the shared document server, and provide a first interface element operative to display the associated note. The processing unit may be further operative to determine whether the associated note comprises a high priority note and display the high priority note simultaneously with the document prior to receiving a user selection of the provided first interface element. The processing unit may also provide a second interface element operative to receive note-related information comprising at least one of: at least one new note, at least one edit to the at least one displayed note, and a request to delete the at least one displayed note; store the note-related information received by the second interface element on the shared document server; communicate periodically with the shared document server to determine whether at least one second note has been associated with the document; and retrieve the at least one second note from the shared document server.

FIG. 5 is a block diagram of a system including computing device 500. Consistent with an embodiment of the invention, the aforementioned memory storage and processing unit may be implemented in a computing device, such as computing device 500 of FIG. 5. Any suitable combination of hardware, software, or firmware may be used to implement the memory storage and processing unit. For example, the memory storage and processing unit may be implemented with computing device 500 or any of other computing devices 518, in combination with computing device 500. The aforementioned system, device, and processors are examples and other systems, devices, and processors may comprise the aforementioned memory storage and processing unit, consistent with embodiments of the invention. Furthermore, computing device 500 may comprise an operating environment for system 100 as described above. System 100 may operate in other environments and is not limited to computing device 500.

With reference to FIG. 5, a system consistent with an embodiment of the invention may comprise a computing device, such as computing device 500. In a basic configuration, computing device 500 may comprise at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may comprise operating system 505, one or more programming modules 506, and may comprise a program data store 507. Operating system 505, for example, may be suitable for controlling computing device 500's operation. In one embodiment, programming modules 506 may comprise a document editing application 520 configured to retrieve and open shared documents. Furthermore, embodiments of the invention may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also comprise additional data storage devices (removable and/or non-removable) such as, for example, magnetic disks, optical disks, or tape. Such additional storage is illustrated in FIG. 5 by a removable storage 509 and a non-removable storage 510. Computer storage media may comprise volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e. memory storage.) Computer storage media may comprise, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, etc. Output device(s) 514 such as a display, speakers, a printer, etc. may also be comprised. The aforementioned devices are examples and others may be used.

Computing device 500 may also contain a communication connection 516 that may allow device 500 to communicate with other computing devices 518, such as over a network in a distributed computing environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and comprises any information delivery media. The term “modulated data signal” may describe a signal that has one or more characteristics set or changed in such a manner as to encode information in the signal. By way of example, and not limitation, communication media may comprise wired media such as a wired network or direct-wired connection, and wireless media such as acoustic, radio frequency (RF), infrared, and other wireless media. The term computer readable media as used herein may comprise both storage media and communication media.

As stated above, a number of program modules and data files may be stored in system memory 504, including operating system 505. While executing on processing unit 502, programming modules 506 (e.g. a document editing application 520) may perform processes including, for example, one or more of method 200's stages as described above. The aforementioned process is an example, and processing unit 502 may perform other processes. Other programming modules that may be used in accordance with embodiments of the present invention may comprise electronic mail and contacts applications, word processing applications, spreadsheet applications, database applications, slide presentation applications, drawing or computer-aided application programs, etc.

Generally, consistent with embodiments of the invention, program modules may comprise routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may comprise the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing document information, the method comprising:
storing at least one note associated with a document;
displaying the document;
retrieving the at least one note associated with the document; and
providing an interface element operative to display the at least one note.

2. The method of claim 1, wherein the at least one note comprises information about the document to be shared with a plurality of users of the document.

3. The method of claim 1, further comprising:
determining whether the at least one note comprises a high priority note; and
in response to determining that the at least one note comprises a high priority note, displaying the high priority note.

4. The method of claim 2, wherein displaying the high priority note further comprises displaying a high priority indicator.

5. The method of claim 3, wherein the high priority indicator comprises at least one of: a colored line, an icon, a background color, a background pattern, and a border.

6. The method of claim 2, further comprising:
determining whether at least one second note is associated with the document as a reply to the high priority note; and
in response to determining that the at least one second note is associated with the document as a reply to the high priority note, displaying the at least one second note.

7. The method of claim 5, wherein displaying the at least one second note comprises displaying the at least one second note below the high priority note.

8. The method of claim 1, further comprising:
receiving a selection of the interface element operative to display the at least one note; and
displaying the at least one note as an overlay of the document.

9. The method of claim 7, wherein the overlay is operative to receive at least one of: at least one new note, at least one edit to the at least one displayed note, and a request to delete the at least one displayed note.

10. The method of claim 8, further comprising:
receiving the at least one new note;
storing the at least one new note; and
associating the at least one new note with the document.

11. The method of claim 1, further comprising:
receiving a selection of the interface element operative to display the at least one note;
replacing the displayed document with a display of the at least one note; and
displaying a smaller version of the displayed document adjacent to the display of the at least one note.

12. The method of claim 8, wherein displaying the at least one note comprises displaying at least one of: a name of an author of the at least one note, a picture of the author of the at least one note, a priority icon, and a communicator icon.

13. The method of claim 1, further comprising:
determining whether at least one new note has been associated with the document; and
retrieving the at least one new note associated with the document.

14. The method of claim 12, wherein determining whether the at least one new note has been associated with the document occurs at a periodic time interval.

15. The method of claim 12, wherein determining whether the at least one new note has been associated with the document occurs in response to a request from a user.

16. A system for providing information about a document, the system comprising:
a memory storage; and
a processing unit coupled to the memory storage, wherein the processing unit is operative to:
store the document, wherein the document comprises a document accessible to a plurality of users;
store at least one note associated with the document;
receive a request to open the document;
in response to receiving the request to open the document:
display the document, and
provide the at least one note associated with the document for display.

17. The system of claim 16, wherein being operative to provide the at least one note associated with the document for display comprises being operative to:
determine whether the at least one note comprises a high priority note; and
in response to determining that the at least one note comprises the high priority note, display the high priority note.

18. The system of claim 16, wherein the system comprises a shared document server.

19. The system of claim 18, further comprising a client system, wherein the client system comprises:
a second memory storage; and
a second processing unit coupled to the second memory storage, wherein the second processing unit is operative to:
receive a command from at least one of the plurality of users to open the document;
send a request to the shared document server for the document;
receive the document;
receive the at least one note associated with the document;
provide a user interface menu element operative to display the at least one note; and
display the document.

20. A computer-readable medium which stores a set of instructions which when executed performs a method for providing document information, the method executed by the set of instructions comprising:
storing at least one document on a shared document server;
storing at least one note associated with the document on the shared document server;
retrieving the document and the at least one note from the shared document server;
providing a first interface element operative to display the at least one note;
determining whether the at least one note comprises a high priority note;
in response to determining that the at least one note comprises a high priority note, displaying the high priority note and the document simultaneously;
providing a second interface element operative to receive note-related information comprising at least one of: at least one new note, at least one edit to the at least one displayed note, and a request to delete the at least one displayed note;
storing the note-related information received by the second interface element on the shared document server;
communicating periodically with the shared document server to determine whether at least one second note has been associated with the document; and
in response to determining that the at least one second note has been associated with the document, retrieving the at least one second note from the shared document server.
